(19) United States
(12) Patent Application Publication
(10) Pub. No.: US 2025/0105477 A1
(43) Pub. Date: Mar. 27, 2025

(54) ENERGY STORAGE CELL

(71) Applicant: TOYOTA JIDOSHA KABUSHIKI KAISHA, Toyota-shi (JP)

(72) Inventors: Kazuhito KATO, Toyota-shi (JP); Junta Takasu, Nagoya-shi (JP); Atsushi Yamanaka, Nagoya-shi (JP); Masato Ono, Nagoya-shi (JP); Satoshi Moriyama, Nagoya-shi (JP); Kosuke Suzuki, Toyota-shi (JP); Kazuki Sugie, Miyoshi-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 18/636,616

(22) Filed: Apr. 16, 2024

(30) Foreign Application Priority Data
Sep. 27, 2023 (JP) 2023-165210

(51) Int. Cl. H01M 50/586; H01M 10/04; H01M 50/107; H01M 50/167; H01M 50/186

(52) U.S. Cl. CPC H01M 50/586; H01M 10/0431; H01M 50/107; H01M 50/167; H01M 50/186

(57) ABSTRACT

In an energy storage cell according to the present disclosure, a wound electrode assembly includes a first electrode and a second electrode. A first current collector member is connected to the first electrode. A second current collector member is connected to the second electrode. A lid includes a first external terminal and a second external terminal. The first external terminal is disposed so as to overlap the radial center of the wound electrode assembly as viewed in an axial direction. The second external terminal is fixed to a case body. The first current collector member is connected to the first external terminal. The second current collector member is disposed between the case body and the second external terminal. The second current collector member is joined to the second external terminal by being, together with the second external terminal, fixed to the case body.

### CROSS-REFERENCE TO RELATED APPLICATION

This application claims priority to Japanese Patent Application No. 2023-165210 filed on Sep. 27, 2023, incorporated herein by reference in its entirety.

### BACKGROUND

### 1. Technical Field

The present disclosure relates to energy storage cells.

### 2. Description of Related Art

Japanese Patent No. 3322321 (JP 3322321 B) discloses a non-aqueous electrolyte secondary cell as an energy storage cell. In this non-aqueous electrolyte secondary cell, a negative electrode and a positive electrode are wound with a porous separator interposed therebetween, and placed into a cylindrical container. Leads extend from the positive and negative electrodes. The cylindrical container is made of stainless steel. A container lid is welded to the peripheral edge of an opening of the container. A positive electrode terminal and a negative electrode terminal are provided in part of the container lid.

### SUMMARY

In the case where both a positive electrode terminal and a negative electrode terminal are provided in a lid as in the energy storage cell disclosed in JP 3322321 B, the distance between positive and negative electrode leads in a container is relatively small. Accordingly, there is a risk of the leads contacting each other and being short-circuited.

The present disclosure was made in view of the above problem, and it is an object of the present disclosure to provide an energy storage cell that reduces short-circuiting in a cell case.

An energy storage cell according to a first aspect of the present disclosure includes a wound electrode assembly, a cell case, a first current collector member, and a second current collector member. The wound electrode assembly includes a first electrode and a second electrode. The cell case houses the wound electrode assembly. The first current collector member is connected to the first electrode. The second current collector member is connected to the second electrode. The cell case includes a case body and a lid. The case body has an opening that opens on one side in an axial direction of the wound electrode assembly as viewed from the wound electrode assembly. The lid closes the opening of the case body. The lid includes a first external terminal and a second external terminal. The first external terminal is disposed so as to overlap a radial center of the wound electrode assembly as viewed in the axial direction. The second external terminal is fixed to the case body. The first current collector member is disposed on the one side in the axial direction of the wound electrode assembly. The first current collector member is connected to the first external terminal. The second current collector member is disposed on the one side in the axial direction of the wound electrode assembly. The second current collector member is disposed between the case body and the second external terminal. The second current collector member is joined to the second external terminal by being, together with the second external terminal, fixed to the case body.

With the above configuration, the second external terminal and the second current collector member are joined to each other at a position relatively distant from the first current collector member connected to the first external terminal. Short-circuiting between the first current collector member and the second current collector member can thus be reduced. With the above configuration, it is possible to provide an energy storage cell that reduces short-circuiting in a cell case.

An energy storage cell according to a second aspect of the present disclosure includes a wound electrode assembly, a cell case, a first current collector member, and a second current collector member. The wound electrode assembly includes a first electrode and a second electrode. The cell case houses the wound electrode assembly. The first current collector member is connected to the first electrode. The second current collector member is connected to the second electrode. The cell case includes a case body and a lid. The case body is electrically conductive, and has an opening that opens on one side in an axial direction of the wound electrode assembly as viewed from the wound electrode assembly. The lid closes the opening of the case body. The lid includes a first external terminal and a second external terminal. The first external terminal is disposed so as to overlap a radial center of the wound electrode assembly as viewed in the axial direction. The second external terminal is directly joined to the case body. The first current collector member is disposed on the one side in the axial direction of the wound electrode assembly. The first current collector member is connected to the first external terminal. The second current collector member is disposed on the other side in the axial direction of the wound electrode assembly. The second current collector member is directly connected to the case body.

With the above configuration, the second external terminal and the second current collector member are electrically connected to each other via the case body at a position relatively distant from the first current collector member connected to the first external terminal. Short-circuiting between the first current collector member and the second current collector member can thus be reduced. With the above configuration, it is possible to provide an energy storage cell that reduces short-circuiting in a cell case.

According to the present disclosure, short-circuiting in a cell case can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating an energy storage cell according to a first embodiment;

FIG. 2 is a cross-sectional view of the energy storage cell of FIG. 1 as viewed along the arrow of II-II line; and

FIG. 3 is a cross-sectional view illustrating an energy storage cell according to a second embodiment.

### DETAILED DESCRIPTION OF EMBODIMENTS

Hereinafter, an energy storage cell according to each embodiment of the present disclosure will be described with reference to the drawings. The same or corresponding parts in the drawings are denoted by the same reference numerals, and the description thereof will not be repeated.

### First Embodiment

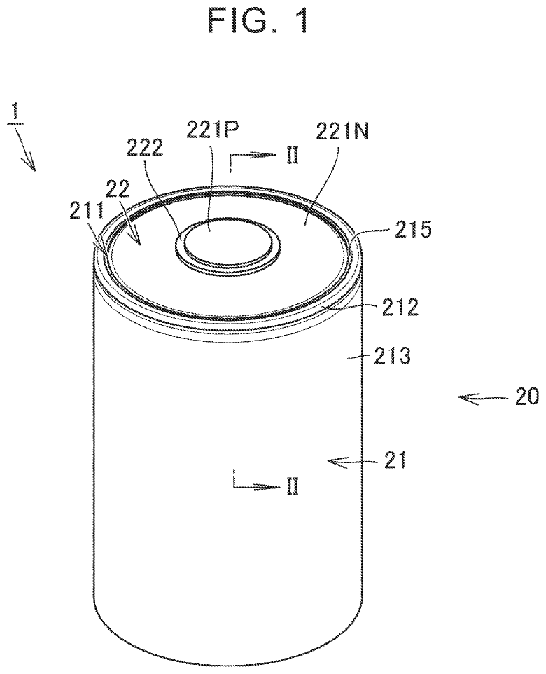

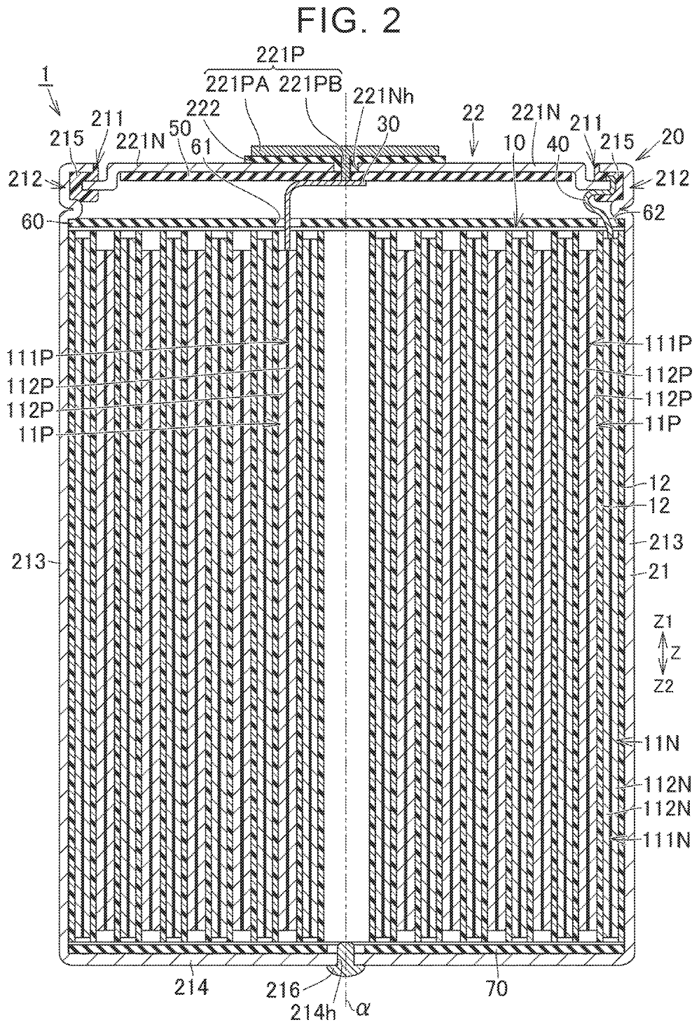

FIG. 1 is a perspective view illustrating an energy storage cell according to a first embodiment. FIG. 2 is a cross-sectional view of the energy storage cell of FIG. 1 as viewed along the arrow of II-II line.

As shown in FIGS. 1 and 2, an energy storage cell 1 according to the first embodiment is a cylindrical battery. The energy storage cell 1 includes a wound electrode assembly 10, a cell case 20, a first current collector member 30, and a second current collector member 40.

First, the wound electrode assembly 10 will be described. As shown in FIG. 2, the wound electrode assembly 10 includes a positive electrode 11P, a negative electrode 11N, and separators 12. The wound electrode assembly 10 is wound such that the positive electrode 11P, the negative electrode 11N, and the separators 12 surround the winding shaft line a.

In the first embodiment, a positive electrode 11P is exemplified as the first electrode. In the first embodiment, a negative electrode 11N is exemplified as the second electrode. However, the first electrode may be a negative electrode. The second electrode may be a positive electrode.

The positive electrode 11P and the negative electrode 11N have a sheet-like outer shape. The wound electrode assembly 10 includes an electrode plate group in which a positive electrode 11P and a negative electrode 11N are wound with separators 12 interposed therebetween.

The separators 12 are provided between the positive electrode 11P and the negative electrode 11N. The separators 12 separate the positive electrode 11P and the negative electrode 11N while allowing ions (e.g., lithium ions) to move back and forth between the positive electrode 11P (positive electrode active material) and the negative electrode 11N (negative electrode active material).

The positive electrode 11P includes a positive electrode collector foil 111P and a positive electrode mixture 112P. The positive electrode collector foil 111P is made of, for example, aluminum.

The positive electrode mixture layers 112P are coated on both radial surfaces of the positive electrode collector foil 111P. The positive electrode mixture layers 112P are in close contact with the separators 12. The positive electrode mixture layers 112P are formed by coating a positive electrode slurry on the positive electrode current collector foil 111P and drying the positive electrode slurry. The positive electrode slurry is a slurry prepared by kneading a material (a positive electrode active material, a binder, or the like) on 112P of the positive electrode mixture layers and solvents. The thickness of the positive electrode mixture 112P is, for example, 0.1 μm or more and 1000 μm or less.

The negative electrode 11N includes a negative electrode current collector foil 111N and a negative electrode mixture 112N. The negative electrode collector foil 111N is made of, for example, copper.

The negative electrode mixture layers 112N are coated on both radial surfaces of the negative electrode current collector foil 111N. The negative electrode mixture layers 112N are in close contact with the separators 12. The negative electrode mixture layers 112N are formed by coating the negative electrode slurry on the negative electrode collector foil 111N and drying the negative electrode slurry. The negative electrode slurry is a slurry prepared by kneading a material (a negative electrode active material, a binder, or the like) on 112N of the negative electrode mixture layers and solvents. The thickness of the negative electrode mixture 112N is, for example, 0.1 μm or more and 1000 μm or less.

Next, the cell case 20 will be described. As shown in FIGS. 1 and 2, the cell case 20 houses the wound electrode assembly 10. The cell case 20 includes a case body 21 and a lid 22.

The case body 21 has an opening 211 that opens on one side (Z1 side in the first direction) in the axial direction Z of the wound electrode assembly 10 as viewed from the wound electrode assembly 10. Specifically, the opening 211 opens toward the Z1 side in the first direction of the case body 21. The case body 21 has a bottomed cylindrical outer shape.

The case body 21 further includes a crimped portion 212 formed by crimping an end portion on one side (Z1 side in the first direction) of the wound electrode assembly 10. The crimped portion 212 extends in an annular shape along the opening 211.

The case body 21 further includes a cylindrical wall portion 213, a bottom portion 214, and a sealing layer 215.

The cylindrical wall portion 213 is provided so as to cover the outer peripheral side of the wound electrode assembly 10. The cylindrical wall portion 213 covers the entire outer peripheral side of the wound electrode assembly 10. The cylindrical wall portion 213 has a cylindrical shape. The cylindrical wall portion 213 may have a rectangular cylindrical outer shape. The cylindrical wall portion 213 is positioned on the Z2 side in the second direction in the axial direction Z as viewed from the crimped portion 212. The cylindrical wall portion 213 is integrally molded with the crimped portion 212.

The bottom portion 214 is disposed on the Z2 side in the second direction along the axial direction Z as viewed from the wound electrode assembly 10. The bottom portion 214 is connected to the end on the Z2 side in the second direction of the cylindrical wall portion 213. In the present embodiment, the bottom portion 214 is integrally formed with the cylindrical wall portion 213. The bottom portion 214 may be formed as a separate member from the cylindrical wall portion 213. At this time, the outer peripheral edge of the bottom portion 214 may be joined to the cylindrical wall portion 213 by laser welding or the like.

A through hole 214h is formed in the bottom portion 214. The through hole 214h may be provided to inject an electrolyte (not shown) contained in the cell case 20. A sealing plug 216 is inserted through the through hole 214h of the bottom portion 214. As a result, the sealing plug 216 is fixed to the bottom portion 214. The sealing plug 216 and the through hole 214h may function as a pressure release valve for releasing the pressure inside the cell case 20 when the pressure inside the cell case 20 becomes excessively high.

The crimped portion 212, the cylindrical wall portion 213, and the bottom portion 214 are electrically conductive. The crimped portion 212, the cylindrical wall portion 213, and the bottom portion 214 are formed of aluminum or an aluminum alloy, copper, stainless steel, or the like.

The sealing layer 215 is disposed radially inward of the crimped portion 212. In the present embodiment, the sealing layer 215 forms the opening 211. The sealing layer 215 extends along the crimped portion 212. The sealing layer 215 has an annular outer shape. The sealing layer 215 is electrically insulating.

The lid 22 closes the opening 211 of the case body 21. The lid 22 includes a positive electrode external terminal 221P, a negative electrode external terminal 221N, and an insulating member 222. In the first embodiment, the positive electrode external terminal 221P is exemplified as the first external terminal. In the first embodiment, the negative electrode external terminal 221N is exemplified as the second external terminal. However, the first external terminal may be a negative external terminal, and the second external terminal may be a positive external terminal.

The positive electrode external terminal 221P is disposed so as to overlap the radial center of the wound electrode assembly 10 as viewed in the axial direction Z. The positive electrode external terminal 221P is made of, for example, aluminum, copper, or stainless steel.

The positive electrode external terminal 221P is disposed on the Z1 side in the first direction of the wound electrode assembly 10. The positive electrode external terminal 221P includes a disc portion 221PA and a rivet portion 221PB.

The disc portion 221PA is exposed to the outside. The disc portion 221PA is positioned opposite to the wound electrode assembly 10 as viewed from the negative electrode external terminal 221N.

The rivet portion 221PB is connected to the disc portion 221PA. The rivet portion 221PB extends from the center of the disc portion 221PA as viewed in the axial direction Z. The rivet portion 221PB is located approximately on the winding axis a of the wound electrode assembly 10. The rivet portion 221PB extends toward the Z2 side in the second direction as viewed from the disc portion 221PA.

The negative electrode external terminal 221N has a plate-like outer shape. Specifically, the negative electrode external terminal 221N has a substantially disk-shaped outer shape. The negative electrode external terminal 221N is provided so as to be perpendicular to the axial direction Z. The negative electrode external terminal 221N is provided with a through hole 221Nh. Therefore, the negative electrode external terminal 221N has a ring-shaped outer shape as viewed in the axial direction Z. A rivet portion 221PB of the positive electrode external terminal 221P is inserted through the through hole 221Nh. Thus, the rivet portion 221PB extends to the inside of the cell case 20.

The negative electrode external terminal 221N is made of aluminum or an aluminum alloy, copper, or stainless steel.

The negative electrode external terminal 221N is fixed to the case body 21. The manner in which the negative electrode external terminal 221N is fixed to the case body will be described later.

The first current collector member 30 is connected to the positive electrode 11P. Specifically, the first current collector member 30 is provided so as to protrude from the positive electrode collector foil 111P of the positive electrode 11P toward one side in the axial direction Z (Z1 side in the first direction). Therefore, the first current collector member 30 is disposed on the one side in the axial direction Z (Z1 side in the first direction) of the wound electrode assembly 10.

The first current collector member 30 is connected to the positive electrode external terminal 221P. Specifically, the first current collector member 30 is welded to the rivet portion 221PB of the positive electrode external terminal 221P.

The first current collector member 30 has a tab lead-like outer shape, but the shape of the first current collector member 30 is not particularly limited. The first current collector member 30 may be a plate-shaped member extending in a plane direction orthogonal to the axial direction Z. The first current collector member 30 is electrically conductive. The material constituting the first current collector member 30 is not particularly limited. The first current collector member 30 may include a positive electrode current collector foil 111P or a positive electrode external terminal 221P.

The second current collector member 40 is connected to the negative electrode 11N. Specifically, the second current collector member 40 is provided so as to protrude from the negative electrode current collector foil 111N of the negative electrode 11N toward one side in the axial direction Z (Z1 side in the first direction). Therefore, the second current collector member 40 is disposed on the one side in the axial direction Z (Z1 side in the first direction) of the wound electrode assembly 10.

The second current collector member 40 is disposed between the case body 21 and the negative electrode external terminal 221N. The second current collector member 40, together with the negative electrode external terminal 221N, is fixed to the case body 21. The second current collector member 40 is thus joined to the negative electrode external terminal 221N. Specifically, the second current collector member 40, together with the negative electrode external terminal 221N, is fixed to the crimped portion 212. In other words, the second current collector member 40, together with the negative electrode external terminal 221N, is crimped and thus fixed to the case body 21.

More specifically, the sealing layer 215 is disposed between the negative electrode external terminal 221N and second current collector member 40 and the crimped portion 212. The sealing layer 215 is provided so as to cover the outer peripheral edge of the negative electrode external terminal 221N and the end of the second current collector member 40 facing away from the negative electrode 11N.

The second current collector member 40 has a tab lead-like outer shape, but the shape of the second current collector member 40 is not particularly limited. The second current collector member 40 may be a plate-shaped member extending in a plane direction orthogonal to the axial direction Z. The second current collector member 40 is electrically conductive. The material constituting the second current collector member 40 is not particularly limited. The second current collector member 40 may include a metallic material included in the negative electrode current collector foil 111N or the negative electrode external terminal 221N.

The energy storage cell 1 according to the present embodiment may further include a first inner insulating member 50, a second inner insulating member 60, and a third inner insulating member 70.

The first inner insulating member 50 is provided on the inner surface of the negative electrode external terminal 221N. The first inner insulating member 50 is provided between the negative electrode external terminal 221N and the first current collector member 30. The first inner insulating member 50 is provided to insulate the negative electrode external terminal 221N from the first current collector member 30.

The second inner insulating member 60 is accommodated in the cell case 20. The second inner insulating member 60 is provided on the Z1 side in the first direction of the wound electrode assembly 10. In the axial direction Z, the second inner insulating member 60 is disposed between the wound electrode assembly 10 and the crimped portion 212. A first through hole 61 and a second through hole 62 are formed in the second inner insulating member 60. The first current collector member 30 is inserted through the first through hole 61. The second current collector member 40 is inserted through the second through hole 62.

The third inner insulating member 70 is accommodated in the cell case 20. The third inner insulating member 70 is provided on the Z2 side in the second direction of the wound electrode assembly 10. The third inner insulating member 70 is provided between the bottom portion 214 and the wound electrode assembly 10. The third inner insulating member 70 is provided to insulate the bottom portion 214 from the wound electrode assembly 10.

As described above, the energy storage cell 1 according to the first embodiment of the present disclosure includes the wound electrode assembly 10, the cell case 20, the first current collector member 30, and the second current collector member 40. The wound electrode assembly 10 includes a positive electrode 11P (first electrode) and a negative electrode 11N (second electrode). The cell case 20 houses the wound electrode assembly 10. The first current collector member 30 is connected to the positive electrode 11P. The second current collector member 40 is connected to the negative electrode 11N. The cell case 20 includes a case body 21 and a lid 22. The case body 21 has an opening 211 that opens on one side in the axial direction Z of the wound electrode assembly 10 as viewed from the wound electrode assembly 10. The lid 22 closes the opening 211 of the case body 21. The lid 22 includes a positive electrode external terminal 221P (first external terminal) and a negative electrode external terminal 221N (second external terminal). The positive electrode external terminal 221P is disposed so as to overlap the radial center of the wound electrode assembly 10 as viewed in the axial direction Z. The negative electrode external terminal 221N is fixed to the case body 21. The first current collector member 30 is disposed on the one side in the axial direction Z of the wound electrode assembly 10. The first current collector member 30 is connected to the positive electrode external terminal 221P. The second current collector member 40 is disposed on the one side in the axial direction Z of the wound electrode assembly 10. The second current collector member 40 is disposed between the case body 21 and the negative electrode external terminal 221N. The second current collector member 40, together with the negative electrode external terminal 221N, is fixed to the case body 21. The second current collector member 40 is thus joined to the negative electrode external terminal 221N.

According to the above configuration, the negative electrode external terminal 221N (second external terminal) and the second current collector member 40 are joined to each other at a position relatively distant from the first current collector member 30 connected to the positive electrode external terminal 221P (first external terminal). Therefore, short-circuiting between the first current collector member 30 and the second current collector member 40 can be reduced. Therefore, according to the above configuration, it is possible to provide the energy storage cell 1 in which short-circuiting inside the cell case 20 is reduced.

In addition, in the present embodiment, the case body 21 further includes a crimped portion 212 formed by crimping the end portion on the one side of the wound electrode assembly 10. The second current collector member 40, together with the negative electrode external terminal 221N (second external terminal), is fixed to the crimped portion 212.

When the case body 21 is connected to the lid 22 by welding, there is a possibility that foreign matter may be mixed into the cell case 20. However, according to the above configuration, as compared with the case where the case body 21 is connected to the lid 22 by welding, entry of foreign matter into the cell case 20 is reduced. Therefore, according to the above configuration, it is possible to provide the energy storage cell 1 that further reduces short-circuiting inside the cell case 20.

In the present embodiment, the case body 21 further includes an electrically insulating sealing layer 215 disposed between the negative electrode external terminal 221N (second external terminal) and the second current collector member 40 and the crimped portion 212.

With the above configuration, it is possible to prevent the negative electrode external terminal 221N (second external terminal) and the member electrically connected to the positive electrode 11P (first electrode) or the positive electrode 11P from being short-circuited through the case body 21.

### Second Embodiment

Next, an energy storage cell according to a second embodiment of the present disclosure will be described. In the second embodiment of the present disclosure, the configuration of the second current collector member is mainly different from the first embodiment of the present disclosure. Therefore, the same configuration and effects as those of the first embodiment of the present disclosure will not be described repeatedly.

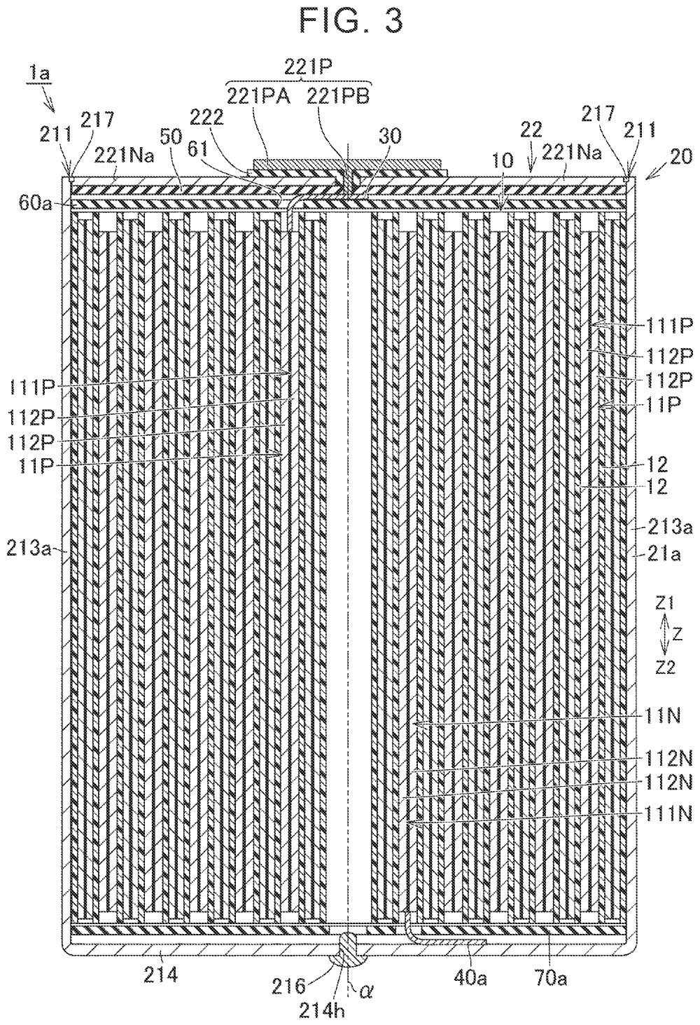

FIG. 3 is a cross-sectional view illustrating an energy storage cell according to a second embodiment. As shown in FIG. 3, in the second embodiment, the case body 21a does not include the crimped portion and the sealing layers shown in the first embodiment. An end on the Z1 side in the first direction of the cylindrical wall portion 213a forms an opening 211. In the present embodiment, the entire case body 21a is electrically conductive.

The negative electrode external terminal 221Na is directly joined to the case body 21a. The negative electrode external terminal 221Na is directly joined to the opening 211 of the case body 21a (cylindrical wall portion 213a). The negative electrode external terminal 221Na is welded to the case body 21a. The negative electrode external terminal 221Na is welded to the opening 211 of the case body 21a (cylindrical wall portion 213a). A welded portion 217 is formed between the negative electrode external terminal 221Na and the case body 21a (cylindrical wall portion 213a).

The second current collector member 40a is provided so as to protrude from the negative electrode collector foil 111N of the negative electrode 11N toward the other side in the axial direction Z (Z2 side in the second direction). Therefore, the second current collector member 40a is disposed on the other side in the axial direction Z (Z2 side in the second direction) of the wound electrode assembly 10.

The second current collector member 40a is directly connected to the case body 21a. The second current collector member 40a may be joined to the case body 21a by welding or the like. The second current collector member 40a is connected to the bottom portion 214. The second current collector member 40a may be connected to the cylindrical wall portion 213a. The second current collector member 40a may be connected to both the bottom portion 214 and the cylindrical wall portion 213a.

In the present embodiment, the second inner insulating member 60a may not have the second through hole as shown in the first embodiment. On the other hand, a third through hole 71 is formed in the third inner insulating member 70a. The second current collector member 40a is inserted into the third through hole 71.

As described above, the energy storage cell la according to the second embodiment of the present disclosure includes the wound electrode assembly 10, the cell case 20, the first current collector member 30, and the second current collector member 40a. The wound electrode assembly 10 includes a positive electrode 11P (first electrode) and a negative electrode 11N (second electrode). The cell case 20 houses the wound electrode assembly 10. The first current collector member 30 is connected to the positive electrode 11P. The second current collector member 40a is connected to the negative electrode 11N. The cell case 20 includes a case body 21a and a lid 22. The case body 21a is electrically conductive, and has an opening 211 that opens on one side in the axial direction Z of the wound electrode assembly 10 as viewed from the wound electrode assembly 10. The lid 22 closes the opening 211 of the case body 21a. The lid 22 includes a positive electrode external terminal 221P (first external terminal) and a negative electrode external terminal 221Na (second external terminal). The positive electrode external terminal 221P is disposed so as to overlap the radial center of the wound electrode assembly 10 as viewed in the axial direction Z. The negative electrode external terminal 221Na is directly joined to the case body 21a. The first current collector member 30 is disposed on the one side in the axial direction Z of the wound electrode assembly 10. The first current collector member 30 is connected to the positive electrode external terminal 221P. The second current collector member 40a is disposed on the other side of the wound electrode assembly 10 in the axial direction Z. The second current collector member 40a is directly connected to the case body 21a.

According to the above configuration, the negative electrode external terminal 221Na (second external terminal) and the second current collector member 40a are electrically connected to each other via the case body 21a at a position relatively distant from the first current collector member 30 connected to the positive electrode external terminal 221P (first external terminal). Therefore, short-circuiting between the first current collector member 30 and the second current collector member 40a can be reduced. Therefore, according to the above configuration, it is possible to provide the energy storage cell la in which short-circuiting in the cell case 20 is reduced.

Further, in the present embodiment, the negative electrode external terminal 221Na (second external terminal) is joined to the case body 21a by welding.

According to the above configuration, it is possible to make the wound electrode assembly 10 and the lid 22 closer to each other than when the negative electrode external terminal 221Na (second external terminal) is joined by crimping the case body 21a. Therefore, the energy density of the energy storage cell la can be improved.

In the description of the above embodiment, combinable configurations may be combined with each other.

The embodiments disclosed herein are to be considered in all respects as illustrative and not restrictive. It is intended that the scope of the disclosure be defined by the appended claims rather than the description of the embodiments described above, and that all changes within the meaning and range of equivalency of the claims be embraced therein.

What is claimed is:

1. An energy storage cell, comprising:
a wound electrode assembly including a first electrode and a second electrode;
a cell case housing the wound electrode assembly;
a first current collector member connected to the first electrode; and
a second current collector member connected to the second electrode, wherein
the cell case includes a case body and a lid,
the case body has an opening that opens on one side in an axial direction of the wound electrode assembly as viewed from the wound electrode assembly,
the lid closes the opening of the case body,
the lid includes a first external terminal and a second external terminal,
the first external terminal is disposed so as to overlap a radial center of the wound electrode assembly as viewed in the axial direction,
the second external terminal is fixed to the case body,
the first current collector member is disposed on the one side in the axial direction of the wound electrode assembly and is connected to the first external terminal, and
the second current collector member is disposed on the one side in the axial direction of the wound electrode assembly and disposed between the case body and the second external terminal, and the second current collector member is joined to the second external terminal by being, together with the second external terminal, fixed to the case body.

2. The energy storage cell according to claim 1, wherein:
the case body further includes a crimped portion created by crimping an end portion of the case body that is located on the one side in the axial direction of the wound electrode assembly; and
the second current collector member, together with the second external terminal, is fixed to the crimped portion.

3. The energy storage cell according to claim 2, wherein the case body further includes an electrically insulating sealing layer disposed between the crimped portion and both the second external terminal and the second current collector member.

4. An energy storage cell, comprising:
a wound electrode assembly including a first electrode and a second electrode;
a cell case housing the wound electrode assembly;
a first current collector member connected to the first electrode; and
a second current collector member connected to the second electrode, wherein
the cell case includes a case body and a lid,
the case body is electrically conductive, and has an opening that opens on one side in an axial direction of the wound electrode assembly as viewed from the wound electrode assembly,
the lid closes the opening of the case body,
the lid includes a first external terminal and a second external terminal,
the first external terminal is disposed so as to overlap a radial center of the wound electrode assembly as viewed in the axial direction,
the second external terminal is directly joined to the case body,
the first current collector member is disposed on the one side in the axial direction of the wound electrode assembly and is connected to the first external terminal, and
the second current collector member is disposed on the other side in the axial direction of the wound electrode assembly and is directly connected to the case body.

5. The energy storage cell according to claim 4, wherein the second external terminal is joined to the case body by welding.
